(19) United States
(12) Patent Application Publication
(10) Pub. No.: US 2012/0313910 A1
(43) Pub. Date: Dec. 13, 2012

(54) PROJECTION TYPE IMAGE DISPLAY DEVICE

(75) Inventors: Masahiro HARAGUCHI, Daito-shi (JP); Masutaka INOUE, Hirakata-shi (JP)

(73) Assignee: SANYO ELECTRIC CO., LTD., Moriguchi-shi (JP)

(21) Appl. No.: 13/490,594

(22) Filed: Jun. 7, 2012

(30) Foreign Application Priority Data
Jun. 10, 2011 (JP) 2011-130248

(51) Int. Cl. G09G 5/00

(52) U.S. Cl. 345/207

(57) ABSTRACT

A projecting unit which projects image light based on an inputted image signal to a projection surface. An invisible light emitter is provided such that an irradiation area of invisible light includes a predetermined region. An image pickup unit receives at least one of a plurality of color lights constituting the image light as well as the invisible light, and which picks up an image of the projection surface to generate a pickup image. An object detector detects at least one of a position and a behavior of an object that has come into the predetermined region based on the pickup image. A display controller changes the projected image based on at least one of the position and the behavior of the object detected by the object detector.

This nonprovisional application is based on Japanese Patent Application No. 2011-130248 filed on Jun. 10, 2011 with the Japan Patent Office, the entire contents of which are hereby incorporated by reference.

### BACKGROUND OF THE INVENTION

1. Field of the Invention

The present invention relates to projection type image display devices, and in particular, to a projection type image display device configured to be capable of changing projection image by a user's interactive operation.

2. Description of the Background Art

Examples of projection type image display devices (hereinafter referred to as projectors) of this type include a projector that projects a projection screen on a wall, as well as a VUI (Virtual User Interface) screen on a desk on which the projector is placed. According to such a projector, when an object (a stylus pen or a user's finger) is placed on the VUI screen, a laser beam directed toward the VUI screen from the projector is scattered by the object. When a light receiving element detects the light scattered by the object, an operational command for switching the projection screen is generated based on the detection signal.

The above projector is a so-called laser projector for displaying an image on a projection screen by irradiating the projection screen with a laser beam, and irradiates the projection screen with a part of the laser beam scanned by the scanning unit, and irradiates a projection plane of the VUI screen with the rest of the laser beam. Then, when the light receiving element detects the light scattered by the object on the desk, a position of the object is calculated based on a scanning position of the laser beam at a timing at which the light receiving element detects the light.

In this manner, according to this projector, it is possible to determine the position of the object on the VUI screen by irradiating the desk with a part of the laser beam applied to the projection screen. However, when the projector is displaying a black screen, a light intensity of the laser beam applied to the desk as the projection plane of the VUI screen is reduced, and therefore it becomes difficult for the light receiving element to accurately detect the scattering light. Further, when an image is projected in a room illuminated by a fluorescent lamp, the light scattered by the object may not be accurately detected due to the reflection of light from the fluorescent lamp on the VUI screen on the desk.

Moreover, according to this projector, in order to calculate the position of the object, it is necessary to synchronize a timing at which a resonant MEMS mirror scans the laser beam with a timing at which the light receiving element detects the scattering light. This requires a light receiving element capable of operating at a high speed, and makes the projector more complicated and expensive.

Additionally, as an object placed outside the VUI screen does not generate scattering light, the light receiving element cannot determine the position of this object. Accordingly, a range in which the user operation is possible is limited to the VUI screen, and it has been difficult to respond to a demand for various interactive features.

### SUMMARY OF THE INVENTION

A projection type image display device according to one aspect of the present invention is provided with: a projecting unit which projects image light based on an inputted image signal to a projection surface; an invisible light emitter configured to emit invisible light to the projection surface, and provided such that an irradiation area of the invisible light includes a predetermined region; an image pickup unit configured to receive at least one of a plurality of color lights constituting the image light as well as the invisible light, and which picks up an image of the projection surface to generate a pickup image; an object detector which detects at least one of a position and a behavior of an object that has come into the predetermined region based on the pickup image; and a display controller which changes the projected image based on at least one of the position and the behavior of the object detected by the object detector.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view illustrating an external configuration of a projector according to an embodiment of the present invention.

FIG. 2 is a perspective view illustrating an internal configuration of a main body cabinet.

FIG. 3 is a schematic structural diagram of a main portion of an image pickup unit illustrated in FIG. 1.

FIG. 4 is a perspective view illustrating a schematic configuration of an infrared light emitter illustrated in FIG. 1.

FIG. 5 is a diagram illustrating a control structure of the projector according to this embodiment.

FIGS. 6A and 6B are conceptual diagrams illustrating a calibration process according to this embodiment.

FIG. 7 is a flowchart illustrating the calibration process according to this embodiment.

FIGS. 8A and 8B are views illustrating one example of projection images in an interactive mode in the projector according to this embodiment.

FIG. 9 is a view illustrating detection of a position of a user operation outside a projection region.

FIG. 10 is a table illustrating one example of contents of user's instructions when set in the interactive mode.

FIG. 11 is a flowchart illustrating an operation of the projector when set in the interactive mode.

FIG. 12 is a flowchart illustrating the operation of the projector when set in the interactive mode.

FIG. 13 is a timing chart illustrating an operation of the infrared light emitter when the projector is set in the interactive mode.

FIG. 14 is a view illustrating one example of a projection image in a standby state in which an operation by the user is awaited.

FIGS. 15A and 15B are views illustrating modified examples of the infrared light emitter according to this embodiment.

FIG. 16 is a view illustrating a modified example of the infrared light emitter according to this embodiment.

### DESCRIPTION OF THE PREFERRED EMBODIMENTS

Hereinafter, an embodiment according to the present invention will be described in detail with reference to the drawings. Like or corresponding components in the drawings are denoted by like reference numerals, and the description for such components will not be repeated.

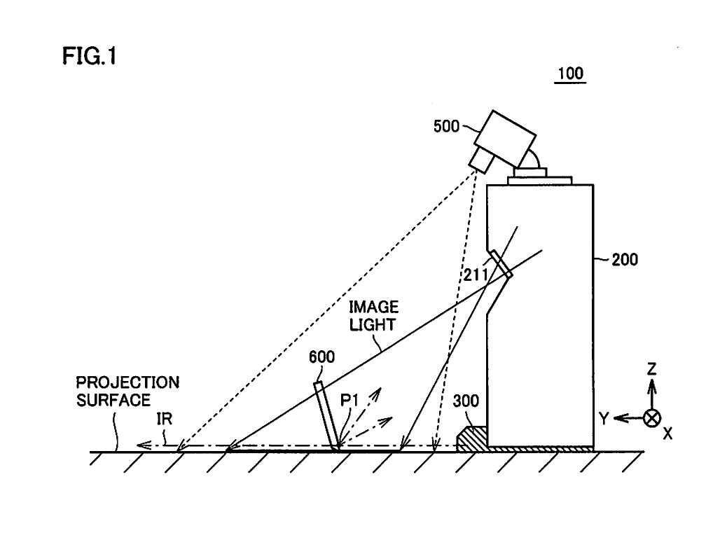

FIG. 1 is a view illustrating an external configuration of a projector according to the embodiment of the present invention. In this embodiment, a side on which a projection surface is positioned and a side opposite from the projection surface centering a projector 100 are respectively defined to be a front side and a back side, a right side facing the projection surface from projector 100 is defined to be a right side, a left side facing the projection surface from projector 100 is defined to be a left side, a direction perpendicular to the forward-backward and rightward-leftward directions and directed toward the projection surface from projector 100 is defined to be a downside, and a side opposite of the downside is defined to be an upside, for convenience sake. Further, the rightward-leftward direction is defined to be an X direction, the forward-backward direction is defined to be a Y direction, and the up and down direction is defined to be a Z direction.

Referring to FIG. 1, projector 100 is a projector of a so-called short focus projection type, and provided with a substantially rectangular main body cabinet 200, an infrared light emitter 300, and an image pickup unit 500.

Main body cabinet 200 is provided with a projection hole 211 for transmitting image light. The image light directed forward and downward through projection hole 211 is extended and projected on a projection surface provided in front of projector 100. In this embodiment, the projection surface is provided on a floor on which projector 100 is placed. In a case in which projector 100 is placed such that a back surface of main body cabinet 200 is in contact with the floor, the projection surface can be provided on a wall surface.

Infrared light emitter 300 is provided on a side of a lower surface of main body cabinet 200. Infrared light emitter 300 emits infrared light (hereinafter also referred to as “IR light”) directed to the front side of projector 100. As illustrated in FIG. 1, infrared light emitter 300 emits the infrared light substantially in parallel with the projection surface (floor). Infrared light emitter 300 is configured to be able to emit the infrared light in a manner that an irradiation area of the infrared light at least includes an area in which projector 100 is able to project the image light (hereinafter referred to as “projection region”).

Infrared light emitter 300 constitutes an “invisible light emitter” according to the present invention. Invisible light refers to light having a wavelength outside a range of visible light, and specific examples include infrared light, far-infrared light, and ultraviolet light. In this embodiment, infrared light emitter 300 is a representative example of the “invisible light emitter”. In other words, instead of infrared light emitter 300, it is possible to use a light emitter emitting invisible light other than infrared light. As illustrated in FIG. 1, infrared light emitter 300 can be separately provided for main body cabinet 200, or can be built within main body cabinet 200.

Image pickup unit 500 is provided on a side of an upper surface of main body cabinet 200. Image pickup unit 500 is provided with such as an image pickup device for example including a CCD (Charge Couple Device) sensor or a CMOS (Completely Metal Oxide Semiconductor) sensor and an optical lens provided in front of image pickup device. Image pickup unit 500 picks up an image of an area including at least the projection region. Image pickup unit 500 generates image data indicating the pickup image (hereinafter referred to as “pickup data”). As illustrated in FIG. 1, image pickup unit 500 can be separately provided for main body cabinet 200, or can be built within main body cabinet 200.

Projector 100 according to this embodiment is configured to be operable selectively in a “normal mode” corresponding to a normal image display operation and an “interactive mode” in which an image projected on the projection surface can be changed based on an interactive operation by the user. The user can select between the normal mode and the interactive mode by operating an operation panel provided for main body cabinet 200 or a remote controller.

When projector 100 is set in the interactive mode, the user can change a display mode of the projection image interactively by performing an operation on the projection image using a finger or a pointer.

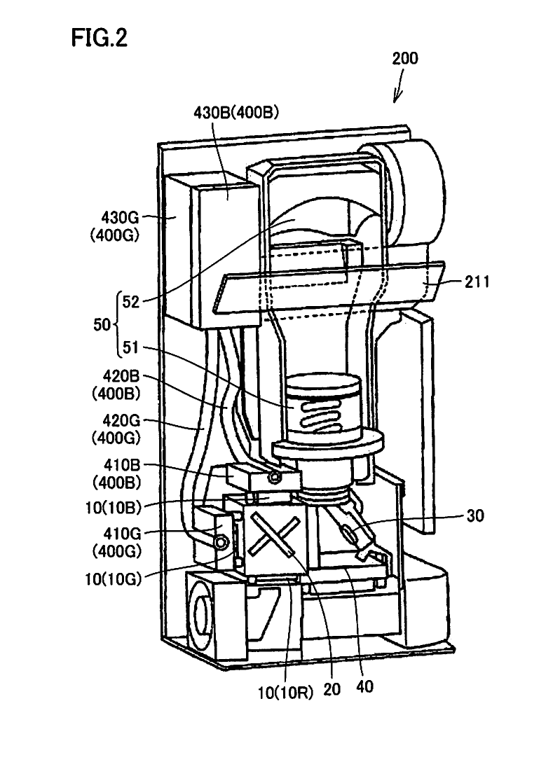

FIG. 2 is a perspective view illustrating an internal configuration of main body cabinet 200.

Referring to FIG. 2, main body cabinet 200 is provided with a light source device 10, a cross dichroic mirror 20, a folding mirror 30, a DMD (Digital Micromirror Device) 40, and a projection unit 50.

Light source device 10 includes a plurality (three, for example) of light sources 10R, 10G, and 10B. Light source 10R is a red light source emitting a light in a red wavelength band (hereinafter referred to as “R light”), and configured by a red LED (Light Emitting Device) or a red LD (Laser Diode), for example. Light source 10R is provided with a cooler 400R (not depicted) configured by a heatsink and a heat pipe for releasing heat generated in light source 10R.

Light source 10G is a green light source emitting a light in a green wavelength band (hereinafter referred to as “G light”), and configured by a green LED or a green LD, for example. Light source 10G is provided with a cooler 400G configured by a heatsink 410G and a heat pipe 420G for releasing heat generated in light source 10G.

Light source 10B is a blue light source emitting a light in a blue wavelength band (hereinafter referred to as “B light”), and configured by a blue LED or a blue LD, for example. Light source 10B is provided with a cooler 400B configured by a heatsink 410B and a heat pipe 420B for releasing heat generated in light source 10B.

Cross dichroic mirror 20 only transmits the B light in the light incident from light source device 10, and reflects the R light and the G light. The B light that has transmitted through cross dichroic mirror 20, and the R light and the G light that have reflected on cross dichroic mirror 20 are directed to and reflected on folding mirror 30, and enter DMD 40.

DMD 40 includes a plurality of micromirrors disposed in matrix. A single micromirror constitutes a single pixel. The micromirrors are driven between on and off at a high speed based on DMD driving signals corresponding to the R light, the G light, and the B light that have entered.

The light from each light source (the R light, the G light, and the B light) is modulated by changing an inclination angle of the micromirrors. Specifically, when a micromirror corresponding to one pixel is in an OFF state, the light reflected on this micromirror does not enter projection unit 50. By contrast, when the micromirror is in an ON state, the light reflected on this micromirror enters projection unit 50. By adjusting a ratio of a time period in which each micromirror is in the ON state to a light emitting period of each light source, gradation of the pixel is adjusted pixel by pixel.

DMD 40 drives each micromirror in synchronization with a timing at which light source device 10 time-divisionally emits the R light, the G light, and the B light. Projection unit 50 includes a pixel 51 and a reflection mirror 52. The light reflected on DMD 40 (image light) is transmitted through a projection lens unit 51 and incident into reflection mirror 52. The image light reflects on reflection mirror 52, and exits outside through projection hole 211 provided for main body cabinet 200. Images respectively in the R, G, and B color lights are sequentially projected on the projection surface. In human eyes, the images in the color lights projected on the projection surface are recognized as a color image generated by overlapping the images in the color lights.

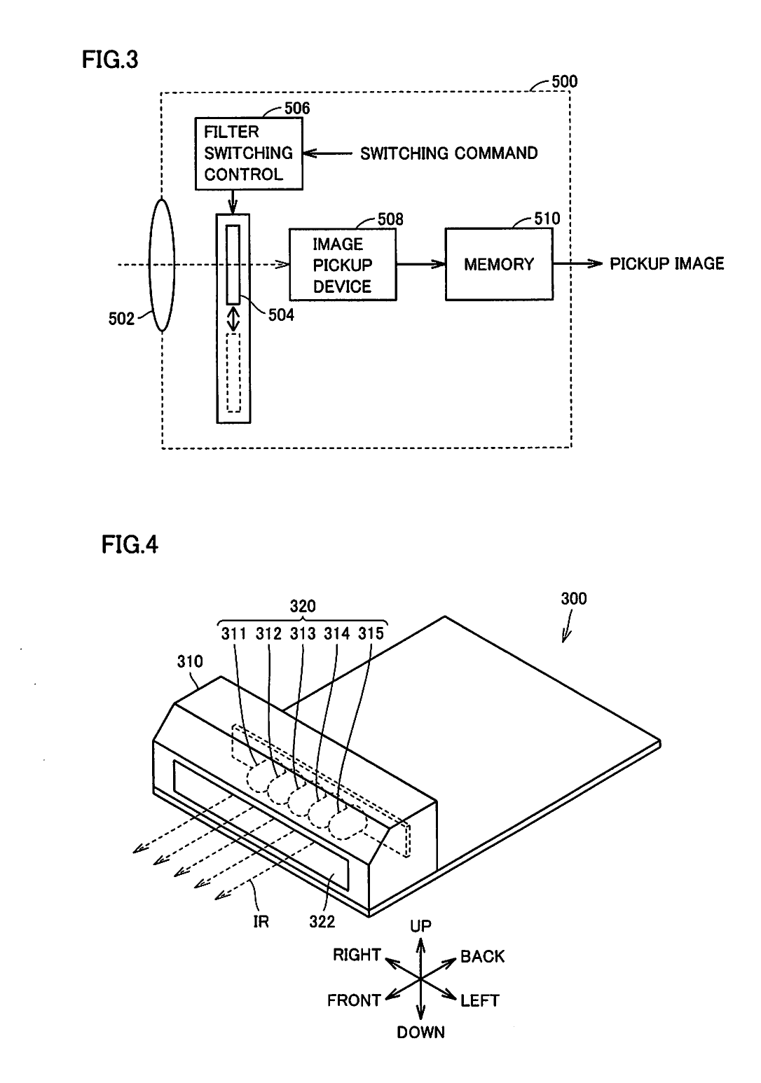

FIG. 3 is a schematic structural diagram of a main portion of image pickup unit 500 illustrated in FIG. 1.

Referring to FIG. 3, image pickup unit 500 includes an optical lens 502, a GB light rejection filter (hereinafter referred to as a “GB cut filter”) 504, a filter switching controller 506, an image pickup device 508, and a memory 510,

Image pickup unit 500 picks up an image of an area including at least the projection region on the projection surface (floor), and generates pickup data. Specifically, image pickup unit 500 takes a predetermined area as a pickup area that sufficiently contains the projection region and includes the projection region and its surrounding area.

An optical image in a field of image pickup unit 500 is applied to a light receiving surface of image pickup device 508, that is, the pickup plane through optical lens 502. On the pickup plane, a charge corresponding to the optical image in the field (pickup data) is generated by photoelectric conversion. GB cut filter 504 is provided between optical lens 502 and image pickup device 508. GB cut filter 504 shields the G light and the B light in the light incident to image pickup device 508, and transmits the R light and the invisible light.

In response to a switching command outputted from main body cabinet 200, filter switching controller 506 selectively drives between a condition in which GB cut filter 504 is inserted into an optical path of image pickup device 508 and a condition in which GB cut filter 504 is removed from this optical path.

In this embodiment, when projector 100 is set in the interactive mode, filter switching controller 506 drives GB cut filter 504 to be in the condition of being inserted into the optical path of image pickup device 508. By contrast, when projector 100 is set in the normal mode, filter switching controller 506 drives GB cut filter 504 to be in the condition of being removed from this optical path. With the above configuration, during the interactive mode, it is possible to determine a content of a user's instruction based on the pickup data generated by image pickup unit 500. By contrast, during the normal mode, it is possible to generate image data representing a content displayed on the projection surface based on the pickup data. For example, by picking up an image in a condition in which such as a letter drawn on the projection image, it is possible to store this condition as a single piece of the image data.

FIG. 4 is a perspective view illustrating a schematic configuration of infrared light emitter 300 illustrated in FIG. 1.

Referring to FIG. 4, infrared light emitter 300 includes a light emission source 320 for emitting infrared light and a housing 310 containing light emission source 320. Light emission source 320 is constituted by a plurality (five, for example) of light emitting elements 311 to 315 for emitting infrared light. Light emitting elements 311 to 315 are configured by a LED, for example. Light emitting elements 311 to 315 are arranged in the X direction (right and left direction).

Optical axes of light emitting elements 311 to 315 lie in parallel with the projection surface (in the Y direction). It is preferable that an interval between the optical axes of light emitting elements 311 to 315 and the projection surface be as short as structurally possible. This is because as a distance of the infrared light from the projection surface increases, inconsistency is likely to occur between a position at which a touch operation is actually performed by the user and a position of the operation detected by scattering light position detector 204, and the interactive feature may not function normally.

Housing 310 is provided with a slit 322 in a side surface on the front side of projector 100. After transmitting slit 322, the infrared light emitted from light emitting elements 311 to 315 travels in substantially parallel with the projection surface.

Here, light emission source 320 is turned on (ON) when projector 100 is set in the interactive mode, and turned off (OFF) when projector 100 is set in the normal mode. With the above configuration, during the interactive mode, it is possible to change the display mode of the projection image by the user performing a touch operation using a finger or a pointer on the projection surface within the irradiation area of the infrared light according to the touched position (position of operation). Further, during the normal mode, it is possible to save power consumption by preventing light emission source 320 from unnecessary emitting light.

FIG. 5 is a diagram illustrating a control structure of projector 100 according to this embodiment.

Referring to FIG. 5, projector 100 is provided with light source device 10 (FIG. 2), DMD 40 (FIG. 2), projection unit 50 (FIG. 2), a projection region detector 202, scattering light position detector 204, an object operation determining unit 206, an element controller 208, a light emission controller 210, a calibration pattern storage unit 212, a image signal processor 214, and an operation accepting unit 216.

Operation accepting unit 216 receives a remote controller signal transmitted from the remote controller operated by the user. Operation accepting unit 216 also accepts a signal form the operation panel provided for main body cabinet 200, in addition to the reception of the remote controller signal. When an operation is made to the remote controller or the operation panel, operation accepting unit 216 accepts the operation, and transmits a command signal triggering various operations to element controller 208.

Image signal processor 214 receives a image signal supplied from an input unit that is not depicted. Image signal processor 214 processes the received image signal into a signal for display and outputs the processed signal. Specifically, image signal processor 214 writes the received image signal into a frame memory (not depicted) for each frame (each screen), and reads the image written into the frame memory. Then, by performing various image processing in the course of processing for writing and reading, image signal processor 214 converts the received image signal to generate a display image signal for the projection image.

Here, examples of the image processing performed by image signal processor 214 include image distortion correction processing for correcting an image distortion due to a relative inclination between an optical axis projection light from projector 100 and the projection surface, and image size adjustment processing for enlarging or reducing a display size of the projection image displayed on the projection surface.

Element controller 208 generates control signals for controlling display operation of the image according to the display image signal outputted from image signal processor 214. The generated control signals are respectively outputted to light source device 10 and DMD 40.

Specifically, element controller 208 controls to drive DMD 40 according to the display image signal. Element controller 208 drives the plurality of micromirrors constituting DMD 40 in synchronization with timings that light source device 10 sequentially emits the R light, the G light, and the B light. With this, DMD 40 modulates the R light, the G light, and the B light based on the display image signal to output the images respectively in the R, G, B color lights.

Further, element controller 208 generates a control signal for controlling intensity of the light emitted from light source device 10 and outputs the generated signal to light source device 10. The control of the intensity of the light emitted from light source device 10 is performed when the user has instructed to adjust brightness of the projection image by operating the remote controller, the operation panel, or a menu screen. Alternatively, it is possible to employ a configuration in which a display controller 208 automatically adjusts the brightness of the projection image according to brightness of the display image signal supplied from image signal processor 214.

### Calibration Process

Projector 100 according to this embodiment executes a calibration process as preprocessing for performing the display operation of the image. The calibration process is for converting an image coordinate system of image pickup unit 500 into a coordinate image system of projector 100. By executing the calibration process, it is possible to execute the interactive mode described above. Here, prior to the execution of the calibration process, a distortion state of the projection image is automatically adjusted.

The calibration process is included in initialization of projector 100 that is performed when the power is activated or the projection is instructed. Other than performing as the initialization, it is also possible to employ a configuration in which the calibration process is performed when such as an inclination sensor that is not depicted detects that the location of projector 100 changes.

Upon instruction of the execution of the calibration process via operation accepting unit 216, display controller 208 causes a predetermined calibration pattern to be projected on the projection surface. The calibration pattern is previously recorded in calibration pattern storage unit 212. In this embodiment, the calibration pattern is an all-white image with which an entire screen is displayed monochromatically in white.

Image pickup unit 500 picks up an image of the projection surface according to an instruction from display controller 208. Image pickup unit 500 generates image data (pickup data) representing the pickup image of the projection surface, and outputs the pickup image to projection region detector 202.

Projection region detector 202 acquires the pickup data from image pickup unit 500, and the image data generated based on the calibration pattern (all-white image, for example) from image signal processor 214. Projection region detector 202 compares the pickup data with the image data, thereby detecting positional information of the projection region in the image coordinate system of image pickup unit 500.

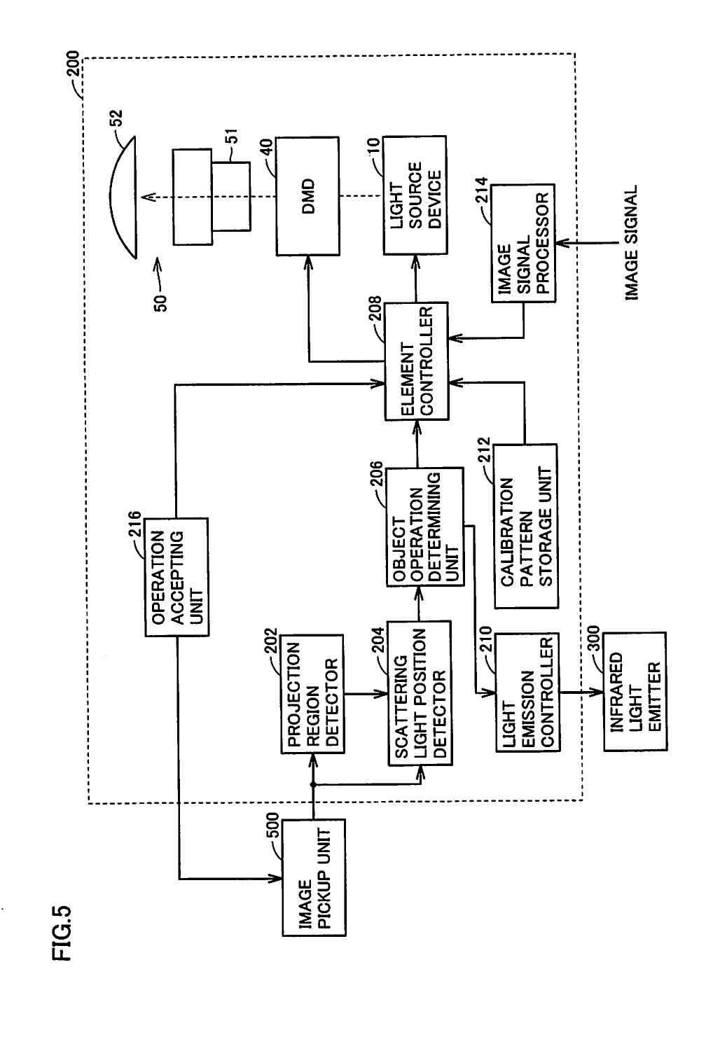

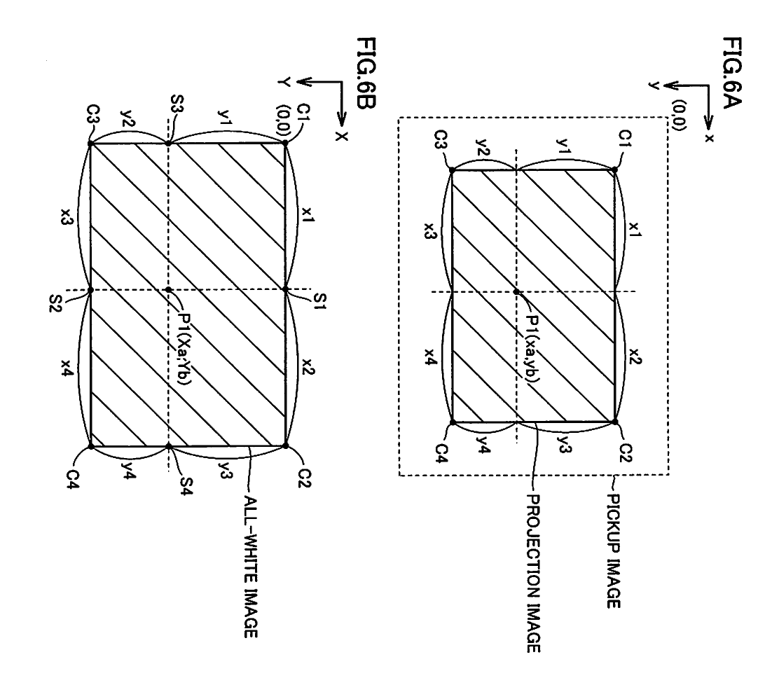

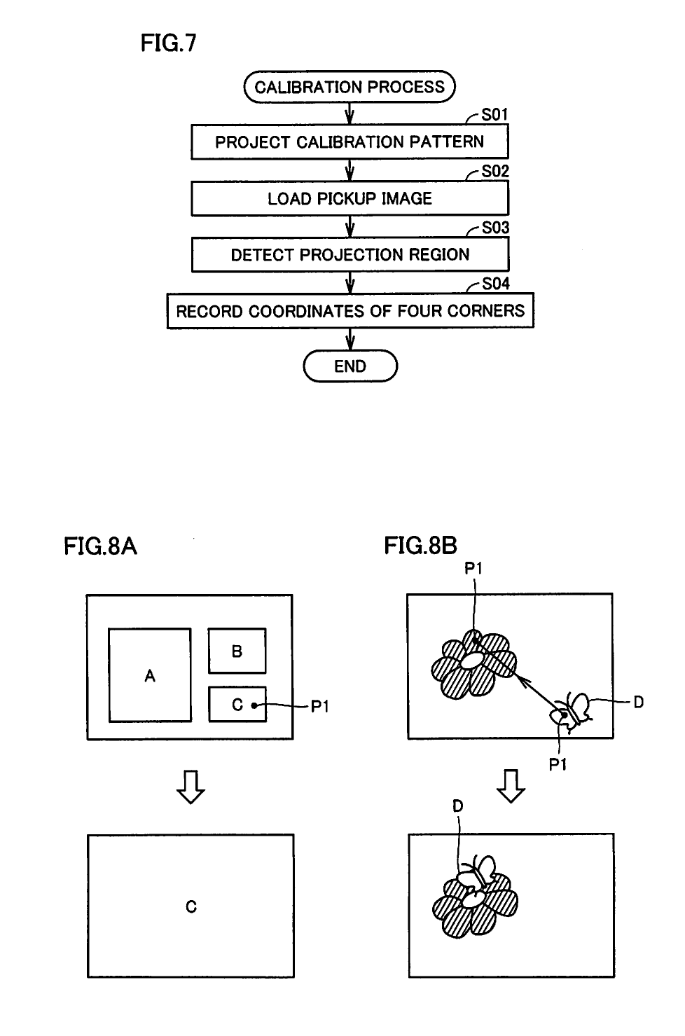

FIGS. 6A and 6B are conceptual diagrams illustrating the calibration process according to this embodiment. FIG. 7 is a flowchart illustrating the calibration process according to this embodiment. Here, FIG. 6B is a diagram illustrating the calibration pattern (all-white image) inputted into display controller 208. FIG. 6A is a diagram illustrating an image of the calibration pattern projected on the projection surface picked up by image pickup unit 500.

In this case, as illustrated in FIG. 6B, an XY coordinate system is assumed in which an upper left corner of an image display region of DMD 40 is taken as an origin (0, 0), a rightward direction is taken as an X direction, and a downward direction is taken as a Y direction. Likewise, as illustrated in FIG. 6A, an xy coordinate system is assumed in which an upper left corner of the pickup image is taken as an origin (0, 0), a rightward direction is taken as an x direction, and a downward direction is taken as a y direction. The pickup image contains the projection image of the calibration pattern that is displayed only in the R light.

Referring to FIG. 7, in Step S01, display controller 208 projects the calibration pattern (all-white image, for example) by driving DMD 40 based on the image data read from calibration pattern storage unit 212.

In Step S02, image pickup unit 500 picks up the image of the projection surface to acquire the pickup image (pickup data).

In Step S03, upon acquisition of the pickup image (FIG. 6A) from image pickup unit 500, projection region detector 202 reads the pickup image sequentially along a predetermined reading direction, thereby detecting xy coordinates of four corners (points C1 to C4 in the drawing) of the projection image in the pickup image. In Step S04, projection region detector 202 records the detected coordinates of the four corners of the projection image as the positional information indicating a position of the projection region in the pickup image.

### (Interactive Mode)

Hereinafter, an operation of projector 100 when set in the interactive mode will be described with reference to the drawings.

Referring to FIG. 1, when projector 100 is set in the interactive mode, infrared light emitter 300 emits the infrared light substantially in parallel with the projection surface (floor). The irradiation area of the infrared light includes at least the projection region of projector 100.

When an object (the user's finger tip or the pointer, for example) 600 comes in the irradiation area of the infrared light, the infrared light is scattered by object 600 to become diverging light. Image pickup unit 500 receives the scattered infrared light. Image pickup unit 500 generates the pickup data based on the image light (the R light) that has transmitted through GB cut filter 504 (FIG. 3) and entered into image pickup device 508 and the infrared light. The pickup data generated by image pickup unit 500 is outputted to projection region detector 202 and scattering light position detector 204 (FIG. 5).

Upon acquisition of the pickup data from image pickup unit 500, scattering light position detector 204 detects a position of the scattered infrared light based on the positional information detected by projection region detector 202 and indicating the position of the projection region in the recorded pickup image. Specifically, scattering light position detector 204 detects the position of the scattered infrared light in the projection region based on positional information of a point having brightness equal to or greater than a predetermined threshold value in the pickup image and the positional information of the projection region. With this, scattering light position detector 204 detects whether or not object 600 has come in the projection region, as well as a position of object 600 that has come in the projection region.

At this time, scattering light position detector 204 detects whether the scattered infrared light is positioned within the projection region or within a predetermined region outside the projection region based on the positional information of the projection region. Then, if the scattered infrared light is positioned within the projection region, scattering light position detector 204 detects the positional information indicating XY coordinates of the scattered infrared light within the projection region. The position of the detected scattered infrared light is at the position of object 600 illustrated in FIG. 1 (point P1), corresponding to the position of operation by the user.

In the following, a method of detecting the position of the scattered infrared light by scattering light position detector 204 illustrated in FIG. 5 will be described with reference to FIGS. 6A and 6B.

As illustrated in FIG. 6A, in the xy coordinate system taking the upper left corner of the pickup image as the origin (0, 0), point P1 indicated by coordinates (xa, yb) is touched to be operated. Scattering light position detector 204 recognizes the position of point P1 within the projection region based on the positional information of the projection region inputted from projection region detector 202. Specifically, an interior division ratio (x1:x2) of point P1 between point C1 and point C2 is calculated based on x coordinates of the upper left corner (point C1) and an upper right corner (point C2) of the projection image and an x coordinate xa of point P1. Similarly, an interior division ratio (x3:x4) of point P1 between point C3 and point C4 is calculated based on x coordinates of a lower left corner (point C3) and a lower right corner (point C4) of the projection image and x coordinate xa of point P1. Further, an interior division ratio (y1:y2) of point P1 between point C1 and point C3 is calculated based on y coordinates of point C1 and point C3 and a y coordinate ya of point P1. Moreover, an interior division ratio (y3:y4) of point P1 between point C2 and point C4 is calculated based on y coordinates of point C2 and point C4 and a y coordinate ya of point P1.

After recognizing the position of point P1 within the projection region as described above, scattering light position detector 204 calculates XY coordinates (Xa, Ya) corresponding to point P1 within the image display region illustrated in FIG. 6B. Specifically, scattering light position detector 204 calculates a point SI that internally divides at a ratio of x1:x2 between the upper left corner (point C1) and the upper right corner (point C2) out of the four corners of the image display region (points C1 to C4 in the drawing), and a point S2 that internally divides at a ratio of x3:x4 between the lower left corner (point C3) and the lower right corner (point C4). Likewise, scattering light position detector 204 calculates a point S3 that internally divides at a ratio of y1:y2 between point C1 and point C3, and a point S4 that internally divides at a ratio of y3:y4 between point C2 and point C4. Then, scattering light position detector 204 recognizes the XY coordinates (Xa, Ya) of a point at which a line segment connecting point Si and point S2 intersects a line segment connecting point S3 and point S4 as the positional information of the point corresponding to point P1 within the image display region.

Referring back to FIG. 5, the positional information of object 600 (positional information of the position of operation) detected by scattering light position detector 204 is transmitted to object operation determining unit 206. Object operation determining unit 206 determines the content of the user's instruction based on the positional information of object 600.

Specifically, when the projection surface is touched and operated, object operation determining unit 206 recognizes the operated position based on the positional information of object 600 supplied from scattering light position detector 204. Then, object operation determining unit 206 determines the content of the user's instruction corresponding to the position of operation.

Alternatively, when the user moves the position of operation while touching and operating the projection surface, object operation determining unit 206 recognizes a movement state of the position of operation (such as a movement direction and movement amount) based on the positional information of object 600 supplied from scattering light position detector 204. Then, object operation determining unit 206 determines the content of the user's instruction corresponding to the movement state of the position of operation.

Image signal processor 214 performs predetermined image processing to a display control signal based on the content of the user's instruction transmitted from object operation determining unit 206 via display controller 208. Element controller 208 controls to drive light source device 10 and DMD 40 according to the processed display image signal. As a result, the display mode of the projection image changes according to the content of the user's instruction.

FIGS. 8A and 8B are views illustrating one example of projection images in the interactive mode in projector 100 according to this embodiment.

As illustrated in FIG. 8A, a projection image constituted by a plurality of images A to C based on a plurality (three, for example) of image signals is displayed on the projection surface. When the user performs a touch operation to image C on the projection image using the finger or the pointer, in projector 100, scattering light position detector 204 detects the positional information of the object on the projection image based on the pickup image of the projection surface. Then, object operation determining unit 206 determines the content of the instruction by the user based on the detected positional information of the object. Image signal processor 214 and display controller 208 change the projection image according to the determined content of the instruction. In the example shown in FIG. 8A, when it is determined that image C has been selected by the user based on the positional information of the object, display controller 208 displays the selected image C in an entire screen.

Further, FIG. 8B shows the projection image with an icon image D as an operation subject displayed with overlapping at an arbitrary position within the screen. When the user performs an operation of dragging and dropping icon image D on the projection image using the finger or the pointer, projector 100 causes icon image D to be displayed at a specified position on the projection screen in response to this operation. Specifically, scattering light position detector 204 detects the positional information of the object on the projection image based on the pickup image on the projection surface. Object operation determining unit 206 detects movement information such as movement direction of the object, a locus of the finger tip, and the position of the finger tip after the movement based on the detected positional information of the object. Then, object operation determining unit 206 determines the content of the instruction by the user based on the detected movement information of the object. Display controller 208 changes the projection image according to the determined content of the instruction.

In the example shown in FIG. 8B, when it is determined that the operation of dragging and dropping icon image D is performed by the user based on the positional information of the object, display controller 208 moves and displays icon image D to and at the specified position.

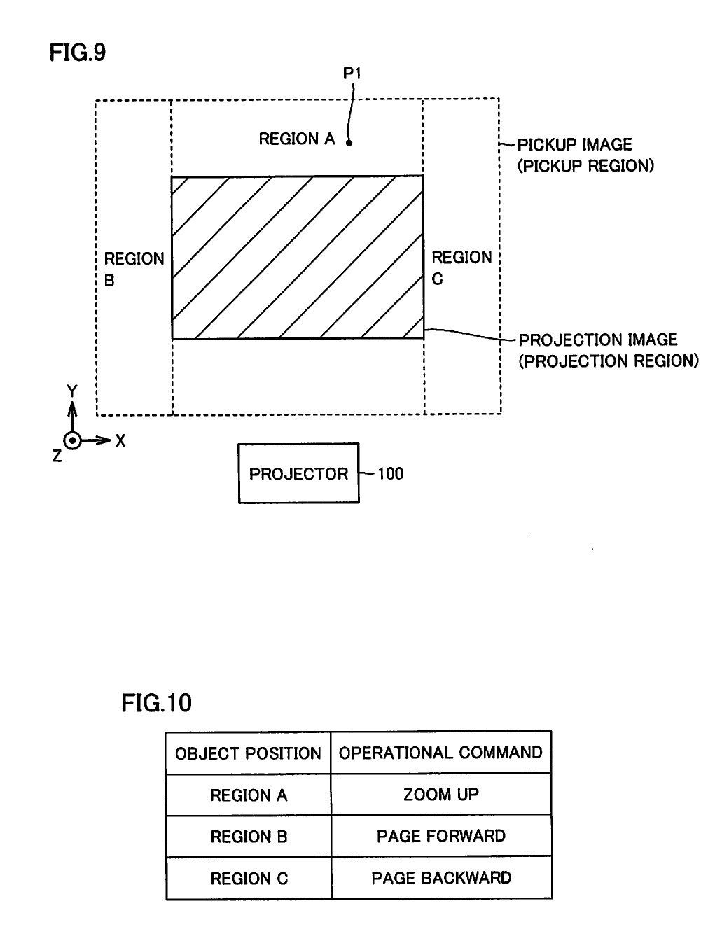

In this manner, according to projector 100 of this embodiment, it is possible to change the projection image by the user operating on the projection image. Further, projector 100 according to this embodiment is able to change the projection image by the user's operation within the region outside the projection region illustrated in FIG. 9. Here, the “region outside the projection region” refers to a region where the irradiation area of the infrared light from the infrared light emitter overlaps with the pickup area of the image pickup unit, and located at an outer periphery of the projection region.

Referring to FIG. 9, the region outside the projection region is divided into three regions A to C. Region A is a region located in front of the projection region, region B is a region located on a left side of the projection region, and region C is a region located on a right side of the projection region.

In this embodiment, a mode of change of the projection image varies depending on the region that the user has performed a touch operation out of three regions A to C. FIG. 10 is a table illustrating one example of contents of the instructions that have been set in association with the regions of the user's touch operation. Referring to FIG. 10, an operational commands is set in association with each piece of the positional information of the object detected by scattering light position detector 204. For example, when the object is located in region A, “zoom-up display” for displaying the projection image enlarged at a predetermined magnification is set. Here, the magnification for displaying the enlarged projection image can be variably set according to the number of times that the user touches region A in a predetermined period of time.

Further, when the object is located in region B, “page forward” for switching the projection image is set. The “page forward” refers to an operation of switching an image of a frame that is currently displayed in the projection surface to an image of a next frame. On the other hand, when the object is located in region C, “page backward” for switching the projection image is set. The “page backward” refers to an operation of switching an image of a frame that is currently displayed in the projection surface to an image of a previous frame.

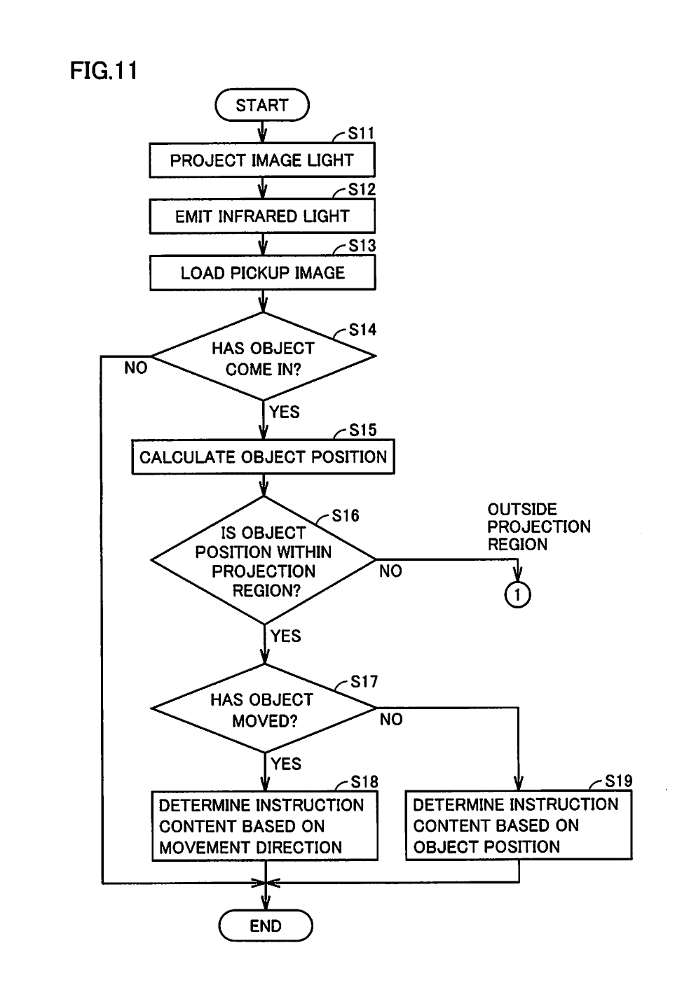

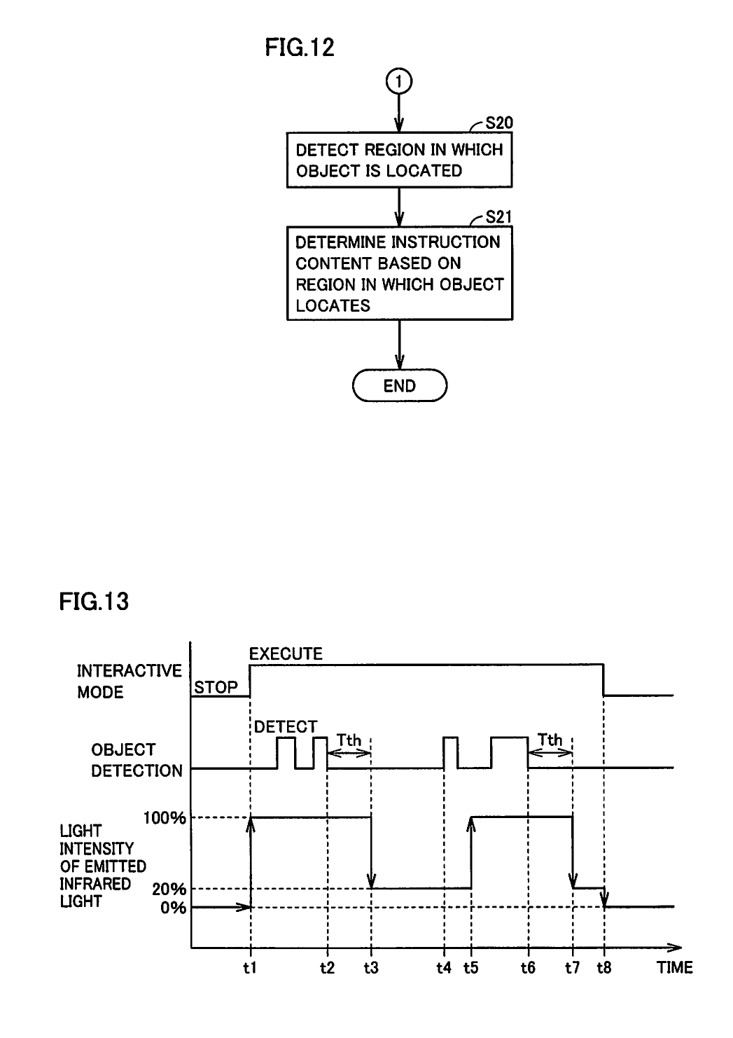

FIGS. 11 and 12 are flowcharts illustrating an operation of projector 100 when set in the interactive mode. The flowcharts shown in FIGS. 11 and 12 are realized by executing a previously stored program in the control structure illustrated in FIG. 5 when projector 100 is set in the interactive mode.

Referring to FIG. 11, Step S11, display controller 208 of projector 100 controls light source device 10 and DMD 40 to project the image light based on the display image signal to the projection surface.

In Step S12, infrared light emitter 300 emits the infrared light substantially in parallel with the projection surface. At this time, all of the plurality of light emitting elements 311 to 315 that constitute light emission source 320 are driven to the ON state.

After reading of the pickup data recorded in memory 510 of image pickup unit 500 in Step S13, in Step S14, scattering light position detector 204 determines whether or not the object has come in the irradiation area of the infrared light based on the pickup data. Specifically, scattering light position detector 204 determines whether or not there is a point having brightness equal to or greater than the predetermined threshold value within the pickup image.

When it is determined that the object has not come in the irradiation area of the infrared light (when determined to be NO in Step S14), scattering light position detector 204 determines that the user has not instructed to change the projection image, and terminates the series of processing.

On the other hand, when it is determined that the object has come in the irradiation area of the infrared light (when determined to be YES in Step S14), in Step S15, scattering light position detector 204 detects the position of the scattered infrared light (the position of the object) based on the positional information of the projection region.

In Step S16, scattering light position detector 204 determines whether or not the scattered infrared light is within the projection region, that is, whether or not the object that has come in is within the projection region, based on the positional information of the projection region. When it is determined that the object is within the projection region (when determined to be YES in Step S16), scattering light position detector 204 detects the positional information indicating XY coordinates of the scattered infrared light within the projection region. The detected positional information of scattering light is outputted to object operation determining unit 206.

In Step S17, object operation determining unit 206 determines whether or not the object has moved based on the positional information of the scattering light. When it is determined that the object has moved (when determined to be YES in Step S17), in Step S18, object operation determining unit 206 determines the content of the user's instruction based on the movement state of the object (the movement direction, the movement amount, and such). By contrast, when it is determined that the object has not moved (when determined to be NO in Step S17), in Step S19, object operation determining unit 206 determines the content of the user's instruction based on the position of the object.

On the other hand, when it is determined that the object is within the predetermined region outside the projection region in Step S16 (when determined to be NO in Step S16), in Step S20, scattering light position detector 204 determines the region in which the object is located, out of the plurality of regions A to C outside the projection region. In Step S21, object operation determining unit 206 determines the content of the user's instruction based on the region in which the object is located.

Upon determination of the content of the user's instruction through Steps S18, S19, and S21, image signal processor 214 performs the predetermined image processing to the display control signal based on the content of the user's instruction transmitted from object operation determining unit 206 via display controller 208. Element controller 208 controls to drive light source device 10 and DMD 40 according to the processed display image signal. As a result, the display mode of the projection image changes according to the content of the user's instruction.

### (Configuration of Infrared Light Emitter)

FIG. 13 is a timing chart illustrating an operation of infrared light emitter 300 when projector 100 is set in the interactive mode.

Referring to FIG. 13, first, at time t1, when projector 100 is set in the interactive mode, infrared light emitter 300 drives all of the plurality of light emitting elements 311 to 315 (FIG. 4) that constitute light emission source 320 to the ON state. Specifically, the emitted light intensity of the infrared light from light emission source 320 is 100% of the emitted light intensity of the infrared light that light emission source 320 can emit. With this, light emission source 320 emits the infrared light such that the pickup area of the image pickup unit is included in the irradiation area of the infrared light. In such a condition, when the image pickup unit receives the scattered infrared light by the object coming within the pickup area, the scattering light position detector detects the position of the scattered infrared light (e.g., the position of the object) within the region outside the projection region within the projection region based on the pickup data from the image pickup unit.

When it is determined that the operation by the user on the projection screen (or in the region outside the projection region) has been completed based on the content of the user's instruction transmitted from object operation determining unit 206, light emission controller 210 (FIG. 5) starts counting time elapsed from the completion of the operation. Specifically, light emission controller 210 counts time elapsed without any operation by the user. As illustrated in FIG. 13, when the user operation has been completed at time t2, and the time elapsed reaches predetermined time Tth (time t3) without any new operation, light emission controller 210 decreases the emitted light intensity of the infrared light from light emission source 320.

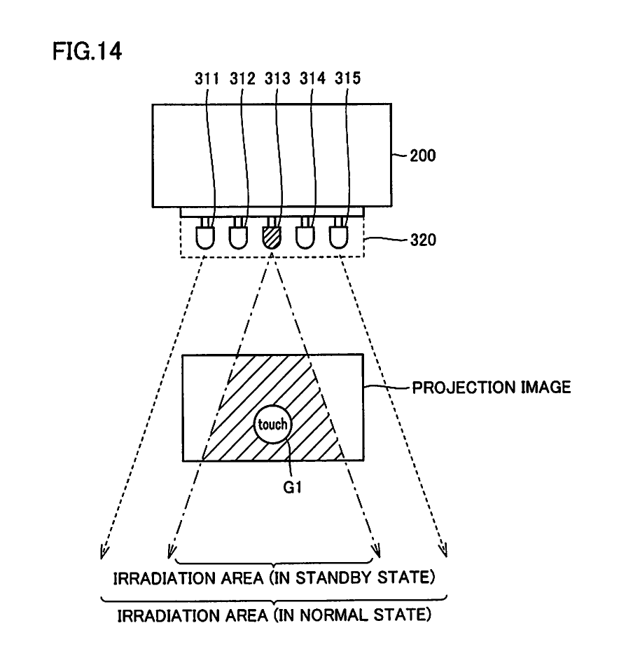

Specifically, light emission controller 210 switches a part of the plurality of light emitting elements 311 to 315 that constitute light emission source 320 from the ON state to the OFF state. At this time, as illustrated in FIG. 14, for example, light emission controller 210 maintains only light emitting element 313 out of light emitting elements 311 to 315 to be in ON state, and drives remaining light emitting elements 311, 312, 314, and 315 to the OFF state. With this, the emitted light intensity of the infrared light from light emission source 320 is reduced down to about 20%.

In this manner, it is possible to reduce electricity consumed by infrared light emitter 300 in a standby state in which an operation by the user is awaited by reducing the emitted light intensity of the infrared light when the time elapsed reaches predetermined time Tth without any operation on the projection screen by the user. As a result, it is possible to reduce power consumption of projector 100.

In contrast, as only light emitting element 313 as a part of the plurality of light emitting elements 311 to 315 is turned to the ON state as described above, the irradiation area of the infrared light becomes smaller than in a normal operation as illustrated in FIG. 14. Therefore, when the user pointed the region outside the irradiation area on the projection image, the scattered infrared light cannot be received by image pickup unit 500 and the operational command from the user may not be determined.

In order to avoid such a trouble, in the standby state in which an operation by the user is awaited, as illustrated in FIG. 14, an image G1 for showing a position to point to the user is displayed with overlapping with the projection image within the region within the projection image corresponding to the irradiation area of the infrared light. When the user points image GI, the scattered infrared light is again received by image pickup unit 500. Referring to FIG. 13, at time t4, when the user points image G1, light emission controller 210 switches light emitting elements 311, 312, 314, and 315 that are in the OFF state to the ON state. With this, the emitted light intensity of the infrared light is resumed to 100%. As a result, the restriction to the irradiation area of the infrared light is lifted.

### MODIFIED EXAMPLE

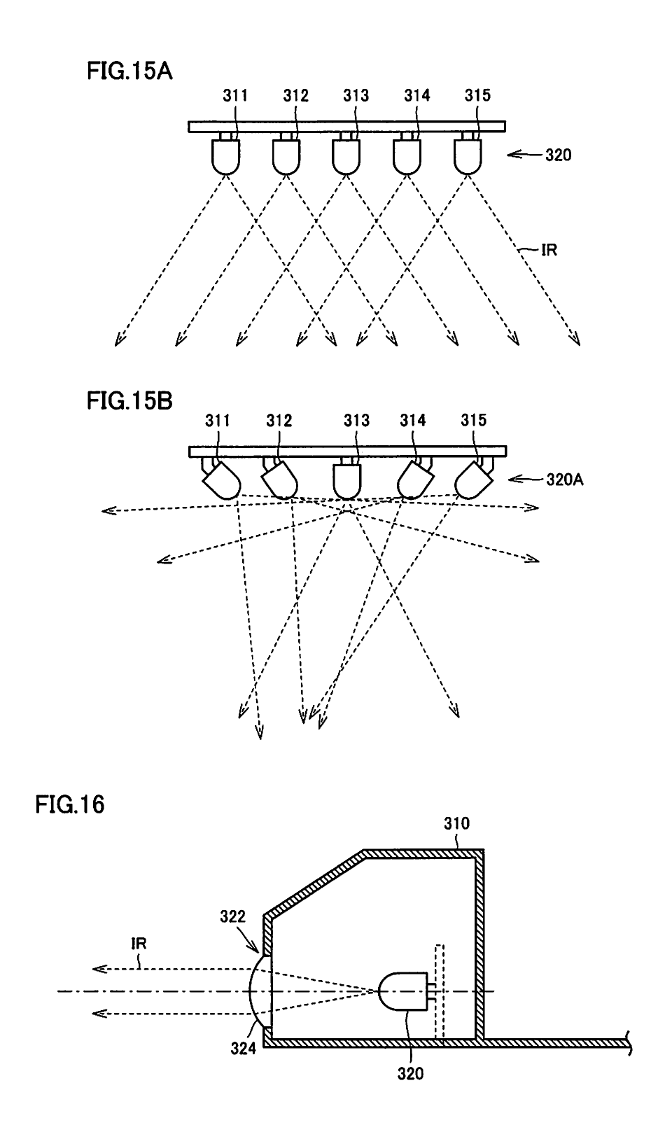

As described above, the plurality of light emitting elements 311 to 315 that constitute light emission source 320 are arranged in the X direction. FIGS. 15A and 15B illustrate, by an example, how light emitting elements 311 to 315 in light emission source 320 are arranged.

The arrangement illustrated in FIG. 15A is the same as that illustrated in FIG. 4.

The plurality of light emitting elements 311 to 315 are arranged such that their optical axes are in parallel with the projection surface as well as that the directions in which the infrared light is emitted are in parallel with each other.

On the other hand, in the arrangement illustrated in FIG. 15B, the plurality of light emitting elements 311 to 315 are arranged such that, similarly to FIG. 15A, their optical axes are in parallel with the projection surface, but that the directions in which the infrared light is emitted are not parallel with each other. In this case, comparing the arrangement illustrated in FIG. 15A with the arrangement illustrated in FIG. 15B, the irradiation area of the infrared light is larger with the arrangement illustrated in FIG. 15B. As a result, according to the arrangement illustrated in FIG. 15B, it is possible to increase an area in which the user can perform a touch operation on the projection surface, and to provide a stronger interactive feature.

Further, as illustrated in FIG. 16, other examples of infrared light emitter 300 include a configuration in which slit 322 is further provided with a cylindrical lens 324. Referring to FIG. 16, cylindrical lens 324 is provided with its longer direction substantially matched with the X direction. By setting curvature of cylindrical lens 324 appropriately, it is possible to concentrate the infrared light emitted from light emission source 320 in the Z direction. With this, it is possible to cause infrared light emitter 300 to emit the infrared light in parallel with the projection surface.

In a case in which the irradiation area of the infrared light is spread in the Z direction, the infrared light is scattered by the user's finger and turned into the diverging light at a timing before the user's finger touches the projection surface. Therefore, inconsistency is likely to occur between the position at which the touch operation is actually performed by the user and the position of the operation detected by scattering light position detector 204, and the interactive feature may not function normally. On the other hand, according to the configuration illustrated in FIG. 16, the inconsistency between the position of the user's operation and the position of the operation detected by scattering light position detector 204 can be reduced, as it is possible to cause the infrared light to travel in parallel with the projection surface. As a result, it is possible to cause the interactive feature to function normally.

In the configuration illustrated in FIG. 16, it is preferable that an interval between an optical axis of cylindrical lens 324 and the projection surface be as short as structurally possible. This is because as a distance of the infrared light from the projection surface increases, the inconsistency described above between the position of the user's operation and the position of the operation detected by scattering light position detector 204 also increases.

Further, while the above embodiment describes the DMD as an example of light modulation devices, it is possible to employ a liquid crystal panel of a reflective type or of a transmission type.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A projection type image display device, comprising:
a projecting unit which projects image light based on an inputted image signal to a projection surface;
an invisible light emitter configured to emit invisible light to said projection surface, and provided such that an irradiation area of said invisible light includes a predetermined region;
an image pickup unit configured to receive at least one of a plurality of color lights constituting said image light as well as said invisible light, and which picks up an image of said projection surface to generate a pickup image;
an object detector which detects at least one of a position and a behavior of an object that has come into said predetermined region based on said pickup image; and
a display controller which changes the projected image based on at least one of the position and the behavior of the object detected by said object detector.

2. The projection type image display device according to claim 1, wherein
said predetermined region includes a projection region of said image light and a region outside said projection region.

3. The projection type image display device according to claim 2, wherein
said display controller divides said region outside said projection region into a plurality of regions, and causes how said projected image is changed when said object is detected to be different between said plurality of regions.

4. The projection type image display device according to claim 1, wherein
said invisible light emitter restricts the irradiation area of said invisible light when predetermined time has elapsed without detecting said object by said object detector.

5. The projection type image display device according to claim 1, wherein
said invisible light emitter includes a plurality of light emitting elements arranged so as to respectively irradiate different regions on said projection surface, and stops driving of a part of said plurality of light emitting elements when predetermined time has elapsed without detecting said object by said object detector.

6. The projection type image display device according to claim 4, wherein
when said object is detected by said object detector in a state in which the irradiation area of said invisible light is restricted, said invisible light emitter lifts the restriction to the irradiation area of said invisible light.

7. The projection type image display device according to claim 6, wherein
when the irradiation area of said invisible light is restricted, said projecting unit displays an image for indicating the irradiation area of said invisible light to the user with overlapping with said image light.
